(19) United States
(12) Patent Application Publication
(10) Pub. No.: US 2014/0283404 A1
(43) Pub. Date: Sep. 25, 2014

(54) FEEDING SYSTEM FOR INJECTION MOLDING MACHINE

(71) Applicant: HON HAI PRECISION INDUSTRY CO., LTD., New Taipei (TW)

(72) Inventor: LI-YING WANG HE, Tu-Cheng (TW)

(73) Assignee: HON HAI PRECISION INDUSTRY CO., LTD., New Taipei (TW)

(21) Appl. No.: 13/947,116

(22) Filed: Jul. 22, 2013

(30) Foreign Application Priority Data
Mar. 21, 2013 (TW) 102110001

(51) Int. Cl. B29C 45/18

(52) U.S. Cl. CPC B29C 45/18
USPC 34/90

(57) ABSTRACT

The feeding system for an injection molding machine includes a drying barrel, a suction pipe, and a pressing cover. The injection molding machine includes a feeding pipe. The drying barrel is configured for receiving material used in the injection molding machine. The suction pipe is connected between the feeding pipe and the drying barrel. The material is configured to be introduced into the feeding pipe through the suction pipe. The pressing cover is slidably received in the drying barrel and configured for pressing the material to squeeze out air existing in the material.

### BACKGROUND

1. Technical Field

The present disclosure relates to a feeding system for an injection molding machine.

2. Description of Related Art

In a feeding system for an injection molding machine, material (such as plastic) is introduced into the injection molding machine by means of suction. Yet, air existing in the feeding system reduces the introduction efficiency of the material.

Therefore, it is desirable to provide a feeding system for an injection molding machine which can overcome the limitations described.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of a feeding system for an injection molding machine according to an exemplary embodiment of the present disclosure.

FIG. 2 is a sectional view of the feeding system of FIG. 1.

### DETAILED DESCRIPTION

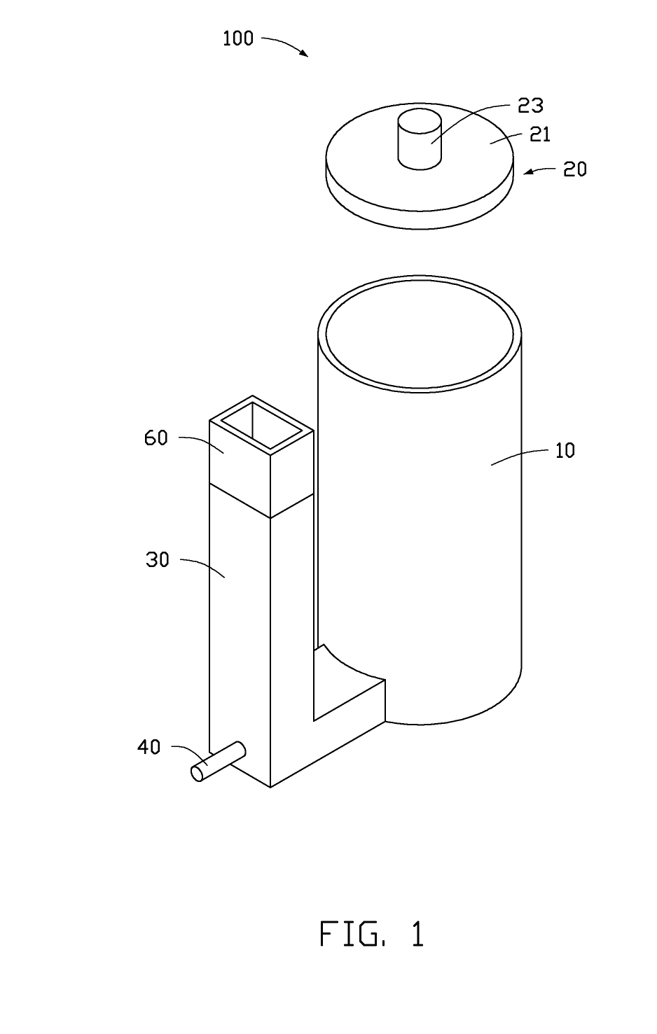

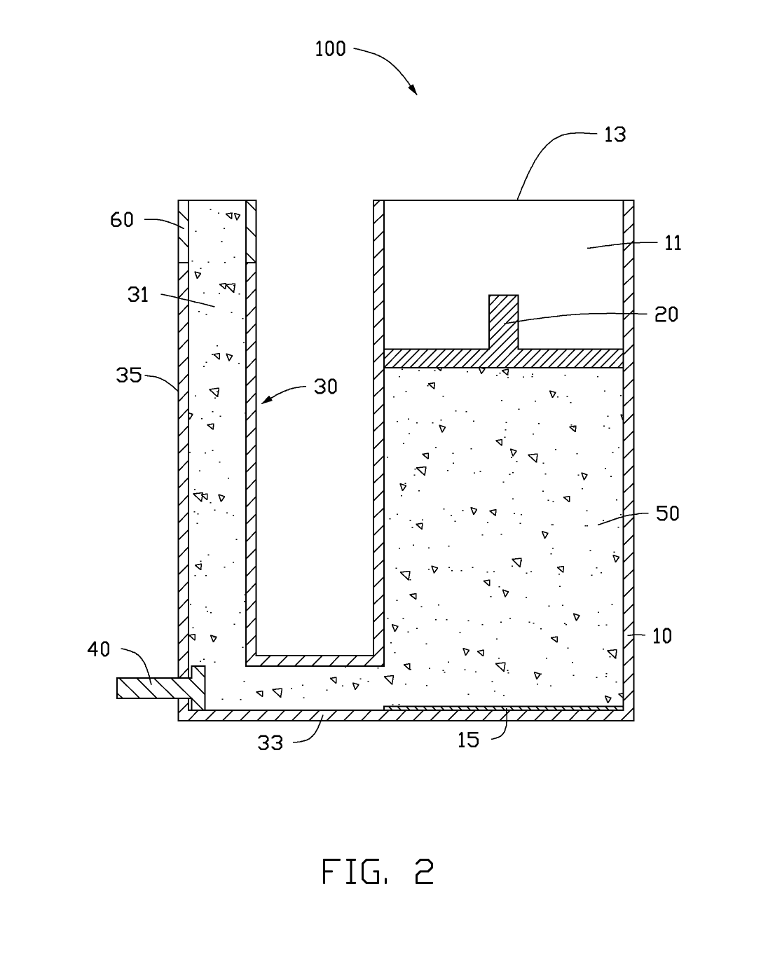

FIGS. 1 and 2 show a feeding system 100 for an injection molding machine according to an exemplary embodiment. The feeding system 100 includes a drying barrel 10, a pressing cover 20, a suction pipe 30 and a valve 40. The drying barrel 10 is in communication with the suction pipe 30. The drying barrel 10 and the suction pipe 30 receive material 50. The material 50 is used in an injection molding process. The suction pipe 30 is in communication with a feeding pipe 60 of the injection molding machine. An air pump (not shown) is in communication with the feeding pipe 60. The material 50 is absorbed by the air pump to move into the feeding pipe 60.

In this embodiment, the drying barrel 10 defines a cylindrical receiving chamber 11. The receiving chamber 11 is closed at a bottom end, and includes an opening 13 at its top end. Material, such as plastic, can be put into the receiving chamber 11 through the opening 13. The drying barrel 10 is made of thermo-conductive material, such as metal. A heating element 15 is mounted on the bottom end of the drying barrel 10. When working, the heating element 15 heats the drying barrel 10 to dry the material 50.

The pressing cover 20 includes a main body 21 and a handle 23 extending from the main body 21. The main body 21 is cylindrical. An operator or a robot arm can hold the handle 23 and drive the pressing cover 20 to move in the drying barrel 10.

When working, the material 50 is continuously introduced into the feeding pipe 60 and the quantity of the material 50 in the drying barrel 10 is continuously reduced. The operator can periodically press the pressing cover 20 towards the bottom end of the drying barrel 10 to squeeze out the air in the material 50, and the introduction efficiency of the material 50 is enhanced.

The suction pipe 30 is substantially L-shaped. The suction pipe 30 defines a hole 31. The suction pipe 30 is connected to the drying barrel 10 at the bottom end. The hole 31 is in communication with the receiving chamber 11. The suction pipe 30 includes a first part 33 connected to the drying barrel 10 and a second part 35 connected to the feeding pipe 60. The valve 40 is mounted at a boundary formed by the first part 33 and the second part 35. The valve 40 can be driven by a driving device to open an end of the hole 31 adjacent to the receiving chamber 11 or close the end of the hole 31.

When the material 50 cannot be introduced into the feeding pipe 60 because of air existing in the drying barrel 10, the operator can drive the valve 40 to close the end of the hole 31, in this way, the hole 31 is isolated from the receiving chamber 11 and air cannot enter the hole 31, and the material 50 in the suction pipe 30 can be introduced into the feeding pipe 60. When the material 50 in the suction pipe 30 are introduced into the feeding pipe 60 and the suction pipe 30 is empty, the operator can drive the valve 40 to open the end of the hole 31, and the material 50 in the receiving chamber 11 can be introduced into the suction pipe 30. The above mentioned steps can be repeated according to actual needs.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A feeding system for an injection molding machine, the injection molding machine comprising a feeding pipe, the feeding system comprising:
a drying barrel configured for receiving material used in the injection molding machine;
a suction pipe connected between the feeding pipe and the drying barrel, the material being configured to be introduced into the feeding pipe through the suction pipe; and
a pressing cover slidably received in the drying barrel and configured for pressing the material to squeeze out air existing in the material.

2. The feeding system of claim 1, wherein the drying barrel defines a receiving chamber for receiving the material.

3. The feeding system of claim 2, wherein the receiving chamber is cylindrical.

4. The feeding system of claim 2, wherein the receiving chamber comprises an opening.

5. The feeding system of claim 2, wherein the suction pipe defines a hole in communication with the receiving chamber, the hole comprises an end adjacent to the receiving chamber, the feeding system comprises a valve mounted in the suction pipe for selectively opening or closing the end.

6. The feeding system of claim 1, wherein the pressing cover comprises a main body and a handle extending from the main body.

7. The feeding system of claim 6, wherein the main body is cylindrical.

8. The feeding system of claim 1, wherein the drying barrel is made of thermo-conductive material.

9. The feeding system of claim 1, comprising a heating element mounted in the drying barrel.
